(19) United States
(12) Patent Application Publication
(10) Pub. No.: US 2013/0277997 A1
(43) Pub. Date: Oct. 24, 2013

(54) Carrier for installing and removing storage batteries from confined spaces

(71) Applicant: ALBERT C. KERSELL, JR., Millbury, MA (US)

(72) Inventor: ALBERT C. KERSELL, JR., Millbury, MA (US)

(21) Appl. No.: 13/506,519

(22) Filed: Apr. 24, 2012

(51) Int. Cl. B66C 1/42

(52) U.S. Cl. 294/118; 294/86.4

(57) ABSTRACT

A storage battery carrier for safely installing and removing storage batteries from cramped confined spaces includes a coupler for rotatably coupling a pair of elongated members together, each elongated member having a substantially flat thin roughened clasping member affixed thereto for clasping the sides of storage batteries of varying widths. Both elongated members have one or more holes therein and the coupler includes a bolt that passes through the holes in the first and second elongated members. The holes are positioned with respect to the very thin flat clasping members so that by selectively passing the bolt through particular holes in the first and second elongated members, the clasping members will be positioned very close to the sides of batteries having a particular width enabling the carrier to safely install and remove batteries from cramped spaces. A simple single strap affixed to the elongated members actuates battery lifting.

### BACKGROUND OF THE INVENTION

I have found it difficult to install and remove storage batteries from cramped confined spaces that contain storage batteries on motorcycles. The sides of the storage batteries must be moved about, e.g. by rocking the batteries back and forth, in removing them from such confined spaces. Furthermore the batteries are heavy so that they can be dropped and injure the person removing or installing the batteries and thus there is a need for the battery carrier to have a very strong grip on the sides of the batteries without straining the person using the battery carrier.

Viola U.S. Pat. No. 4,678,217 discloses a non-adjustable “scissor” storage battery carrier having teeth that can puncture plastic cased batteries and are not wafer thin for grasping storage batteries in tight compartments. Also no spaced series of linear aligned holes are disclosed for providing a substantial adjustment range for large and small batteries.

Rayburn U.S. Pat. No. 4,215,889 and Straus U.S. Pat. No. 4,527,823 utilize two handles which could strain the hand of the user resulting in a “hard squeeze” and would increase manufacturing costs. They also lack a spaced series of linear holes for providing a carrier for storage batteries of various sizes. They also do not disclose substantially flat battery gripping surfaces.

### SUMMARY OF PREFERRED EMBODIMENTS OF THE INVENTION

A storage battery carrier for safely installing and removing storage batteries from cramped confined spaces includes a coupler for rotatably coupling a pair of rigid elongated members together, each elongated member having a substantially flat thin clasping member affixed thereto for clasping the sides of storage batteries of varying widths. At least one of the elongated members have several holes therein and the coupler includes a bolt that passes through the holes in the first and second elongated members. The holes are positioned with respect to the very thin substantially flat clasping members so that by selectively passing the bolt through particular holes in the first elongated member, the clasping members will be positioned very close to the sides of a battery having a particular width, enabling the carrier to safely install and remove batteries from cramped spaces. A simple single strap affixed to the elongated members actuates battery lifting.

### BRIEF DESCRIPTION OF THE DRAWINGS

FIG. 1 is a perspective view of the carrier alongside a storage battery.

FIG. 2 shows the elongated members coincident with one another atop a battery that is to be lifted.

FIG. 3 shows the second elongated member 2 having several holes therein for even further expanding the grasping range of the carrier for lifting batteries of even greater width variations.

### DETAILED DESCRIPTION OF PREFERRED EMBODIMENTS OF THE INVENTION

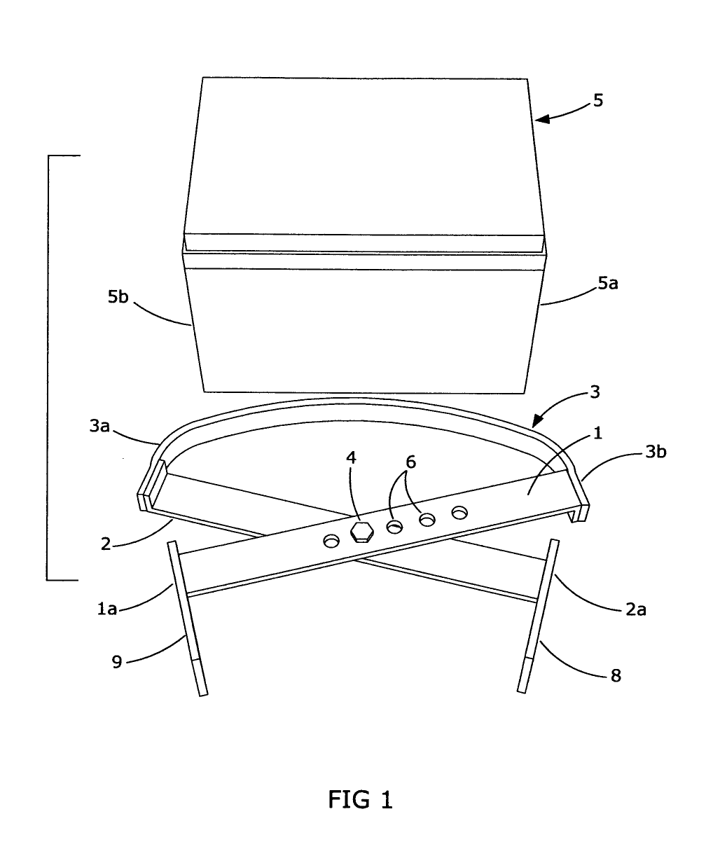

In FIG. 1, a carrier handle, preferably a strap 3 is disclosed, wherein a first elongated member 1 is coupled to a right hand portion of the carrier strap 3b and a second elongated member 2 is coupled to a left hand portion 3a of the carrier strap, and wherein a hole is formed in the second elongated member A plurality of holes 6 are formed, e.g. five, in the first elongated member; and a fastener 4 in the form of a bolt and nut is positioned within one of the holes in the first elongated member and within a hole in the second elongated member (not shown), for rotatably coupling the first and second elongated members together.

A first thin substantially flat clasping member 9 is rigidly coupled to a left hand terminal portion 1a of the first elongated member 1 and a second thin substantially flat clasping member 8 is rigidly coupled to a right hand terminal portion 2a of the second elongated member 2. The two clasping members have a thickness of one quarter of an inch or less and preferably one eighth of an inch.

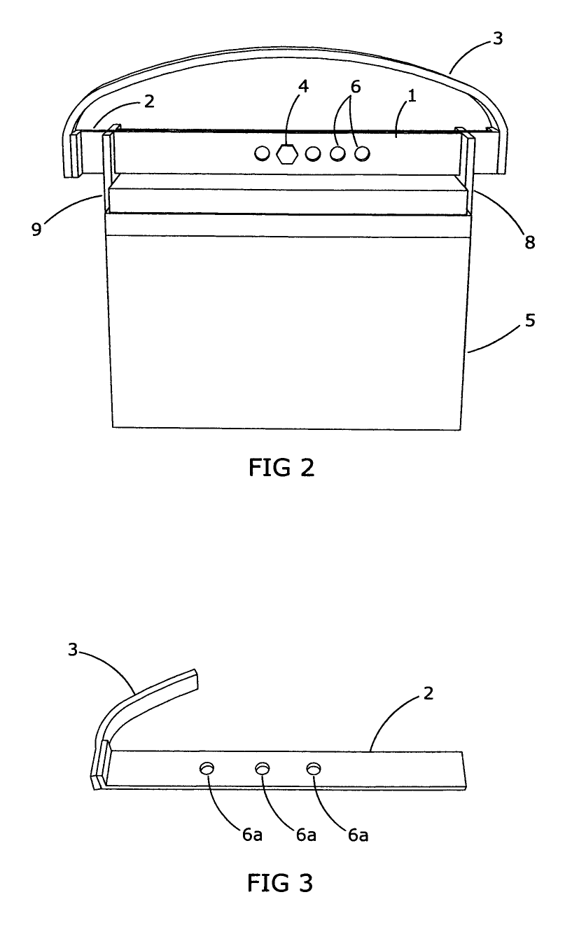

As shown in FIG. 2, a series of five of the holes 6 are formed in the first elongated member 1 for selectively receiving the fastener bolt 4 in one of the holes, and in a hole in elongated member 2, enabling gripping of batteries having substantial dimensional variations.

The first and second thin clasping members 8 and 9 shown in both figures, are thin, substantially flat and have no discreet projections thereon. In my prototype, in order to increase frictional forces for increased gripping security, I roughened the sides of the clasping members by mounting sandpaper cloth binders upon the clasping members. However since sandpaper can be smoothed over through use, I have also considered creating a coarse ground surface directly on the steel clasping members by applying a rotary motor driven grindstone to the clasping member surfaces facing the batteries.

The first and second clasping members that are rotatably coupled together are rotated until the first and second elongated members are aligned with each other over the top of the storage battery and the first and second clasping members are substantially parallel to the sides of the storage battery as shown in FIG. 2. The user then grasps and lifts the handle 3 and causes the first and second clasping members to tightly grip the sides of the storage battery enabling the storage battery to be safely lifted out of, or back into, its confined cramped space.

As shown in FIG. 3, a plurality of holes 6a can be formed in the second elongated member 2 positioned under the first elongated member 1 for further expanding the grasping range of the carrier, enabling lifting of even larger or smaller batteries.

A working prototype was constructed and tested by the inventor for safely gripping and moving a Harley Davidson motorcycle battery part number 66010-97A that weighed about 21.2 pounds and had the following characteristics.

There is a series of five holes in the upper elongated member 1 and a single hole in the lower elongated member 2. The hole diameters are ¼ inches. Each elongated steel member has a length of 7.75 inches, a width of 0.75 of an inch and a thickness of 3/16 of an inch.

The clasping members 8 and 9 have a length of 3⅜ inches, a width of two inches and a thickness of ⅛ of an inch.

The distance between clamping members 8 and 9 when they grip the battery 5 as shown in FIG. 2 is 6½ inches.

2.5×2 inches of sandpaper cloth were bonded to the clasping members.

However, rather than using sandpaper to increase the coefficient of friction, I believe that producing ground surfaces on the clasping members by applying a motor driven grindstone to the clasping members may result in a longer life to the desired roughness versus sandpaper.

While the invention has been described in connection with preferred embodiments, the description is not intended to limit the scope of the invention to the particular forms set forth, but on the contrary, it is intended to cover such alternatives, modifications, and equivalents as may be included within the spirit and scope of the invention as indicated by the language of the following claims.

For example, while the handle 3 is preferably a strap, an expandable handle may be called for where both elongated members have several holes for enabling the carrier to have a further extended range for grasping even larger batteries. Such handles could be chains, or elongated springs or the like. Very large and heavy batteries in future hybrid vehicles could be moved in and out of cramped confined spaces by using a long chain in place of the strap and one or two workers could grasp the chain and transport the batteries.

Rather than rotatably coupling the elongated members together, the elongated members could be coupled together by a track on one of them, enabling them to be shifted or translated with respect to each another along a straight line.

What is claimed is:

1. A storage battery carrier comprising:
(a) a carrier handle;
(b) a first elongated member coupled to a right hand portion of said carrier handle;
(c) a second elongated member coupled to a left hand portion of said carrier handle having at least one hole in the second elongated member;
(d) a plurality of holes in the first elongated member; and
(e) a fastener positioned within a hole in the second elongated member and within a selected hole in the first elongated member for coupling the first and second elongated members together;
(f) a first thin substantially flat clasping member rigidly coupled to a left hand terminal portion of the first elongated member; and
(g) a second thin substantially flat clasping member rigidly coupled to a right hand terminal portion of the second elongated member.

2. The carrier of claim 1 wherein several holes are formed in the first elongated member for selectively receiving the fastener in one of the holes, enabling gripping of batteries having substantial dimensional variations.

3. The carrier of claim 2 wherein a plurality of holes are formed in the second elongated member for expanding the grasping range of the carrier, enabling lifting of larger batteries.

4. The carrier of claim 1 wherein the first and second thin substantially flat clasping members have thicknesses of ¼ inch or less, enabling the carrier to easily install and remove batteries from cramped confined spaces.

5. The carrier of claim 2 wherein the first and second thin substantially flat clasping member have thicknesses of ¼ inch or less, enabling the carrier to easily install and remove batteries from cramped confined spaces.

6. The carrier of claim 3 wherein the first and second thin substantially flat clasping member have thicknesses of ¼ inch or less, enabling the carrier to easily install and remove batteries from cramped confined spaces.

7. The carrier of claim 4 wherein the thin substantially flat clasping members have ground surfaces for increasing gripping frictional forces of said carrier.

8. The carrier of claim 5 wherein the thin substantially flat clasping members have ground surfaces for increasing gripping frictional forces of said carrier.

9. The carrier of claim 6 wherein the thin substantially flat clasping members have ground surfaces for increasing gripping frictional forces of said carrier.

10. The carrier of claim 1 wherein said carrier handle is a single strap.

11. The carrier of claim 2 wherein said carrier handle is a single strap.

12. The carrier of claim 3 wherein said carrier handle is a single strap.

13. A storage battery carrier for installing and removing a storage battery from a confined cramped space comprising:
(a) a carrier handle;
(b) a first elongated member coupled to a right hand portion of said carrier handle;
(c) a second elongated member coupled to a left hand portion of said carrier handle having a hole in the second elongated member;
(d) a coupler for rotatably coupling the first and second elongated members together;
(e) a first thin substantially flat clasping member rigidly coupled to a left hand terminal portion of the first elongated member;
(f) a second thin substantially flat clasping member rigidly coupled to a right hand terminal portion of the second elongated member; and
(g) wherein the first and second thin substantially flat clasping members have a thickness that is less than one quarter of an inch, enabling the carrier to easily install and remove batteries from very cramped confined spaces.

14. The carrier of claim 13 wherein several holes are formed in the first substantially flat elongated member for selectively receiving a coupler fastener to provide for gripping of batteries having substantial dimensional variations.

15. The carrier of claim 14 wherein a plurality of holes are formed in the second substantially flat elongated member for expanding the grasping range of the carrier, enabling lifting of larger batteries.

16. The carrier of claim 13 wherein the thin substantially flat clasping members have ground surfaces for increasing gripping frictional forces of said carrier.

17. The carrier of claim 14 wherein the thin substantially flat clasping members have ground surfaces for increasing gripping frictional forces of said carrier.

18. The carrier of claim 14 wherein said handle is a single strap.

19. The carrier of claim 15 wherein said handle is a single strap.

20. A method of installing and removing a storage battery from a confined cramped space comprising the steps of:
(a) providing a storage battery carrier having
(a-1) a carrier handle;
(a-2) a first elongated member coupled to a right hand portion of said carrier handle;
(a-3) a second elongated member coupled to a left hand portion of said carrier handle having a hole in the second elongated member;
(a-4) a coupler for rotatably coupling the first and second elongated members together;
(a-5) a first thin substantially flat clasping member rigidly coupled to a left hand terminal portion of the first elongated member;
(a-6) a second thin substantially flat clasping member rigidly coupled to a right hand terminal portion of the second elongated member; and
(a-7) wherein the first and second substantially flat clasping members have a thickness of a quarter of an inch or less, enabling the carrier to install and remove batteries from very cramped confined spaces;
(b) rotating the first and second clasping members with respect to each other until the first and second elongated members are aligned with each other over the top of the storage battery and the first and second clasping members are substantially parallel to the sides of the storage battery; and
(c) grasping and lifting the handle for causing the first and second clasping members to tightly grip the sides of the storage battery and for causing the storage battery to be lifted out of said confined space.
